(19) United States
(12) Patent Application Publication
(10) Pub. No.: US 2017/0330423 A1
(43) Pub. Date: Nov. 16, 2017

(54) DERBY RACING GAME

(71) Applicant: MARK HAMILTON JONES AND SHERYL LYNN JONES FAMILY TRUST DATED NOVEMBER 7, 2013, GARDNERVILLE, NV (US)

(72) Inventor: MARK H. JONES, GARDNERVILLE, NV (US)

(21) Appl. No.: 15/632,913

(22) Filed: Jun. 26, 2017

Related U.S. Application Data
(63) Continuation-in-part of application No. 15/593,699, filed on May 12, 2017.
(60) Provisional application No. 62/335,220, filed on May 12, 2016.

(51) Int. Cl. G07F 17/32

(52) U.S. Cl. CPC G07F 17/3288; G07F 17/3276; G07F 17/323; G07F 17/3267

(57) ABSTRACT

A racing game may be played as a table game, and/or with electronic enhancements and includes a race course with a plurality of lanes arranged concentrically and divided into segments, with each of the lanes having the same number of segments. A gamepiece is movable about each of the lanes in a race from an initial position until a winning one of the gamepieces first crosses a finish line. Randomizers select one of the gamepieces to be moved and the number of segments to move. A payout is provided as a portion of the non-winning base wagers or as a multiplier of a base wager placed on the winning one of the gamepieces. An optional second wager may be placed between players and additional, optional bets for short and long games may provide return values that vary depending on the number of rolls in a race. The game can be played using a variety of banking schemes including house banked, player banked, player pool, Class II and Class III.

### CROSS REFERENCE TO RELATED APPLICATION

This application is a Continuation-in-Part of U.S. Utility patent application Ser. No. 15/593,699 filed May 12, 2017 which claims priority to U.S. Provisional Application Ser. No. 62/335,220 filed May 12, 2016, each of which are incorporated herein by reference in their entirety.

### TECHNICAL FIELD

The present disclosure relates generally to a game of chance. More specifically, the present disclosure relates to a racing game of chance and method of playing same.

### BACKGROUND OF THE DISCLOSURE

Games of chance are well-known activities whose outcomes are strongly influenced by randomizing devices and upon which contestants may wager money as they forecast outcomes. Games of chance have been played throughout all of human history, and are considered popular pastimes by many. Players of games of chance are attracted to new and exciting methods of game play. Therefore, there remains a need for new and interesting methods and systems for playing games of chance that maintain player interest and attract new players.

### SUMMARY OF THE INVENTION

According to an aspect of the disclosure, a racing game includes a race course playing surface having a plurality of lanes arranged generally concentrically and divided into a plurality of segments, with each of the lanes having the same number of segments. A finish line may be associated with a last one of the segments of each lane. A gamepiece may be disposed upon and movable about each of the lanes in a race from an initial position on a first one of the segments until one of the gamepieces first crosses the finish line and is thereby designated as a winning gamepiece. A first randomizer may determine a selected one of the gamepieces to be moved, and a second randomizer independent of the first randomizer can determine a number of segments the selected one of the gamepieces is to move within its lane. A wagering area corresponding to each of said gamepieces may be provided for placement of a base wager, which may result in a payout calculated by multiplying a payout multiplier by each of the base wagers placed on the wagering area corresponding to the winning one of the gamepieces. As used in the present application, the word “roll” refers to an event of moving a selected one of the gamepieces and may include one or more separate randomized components such as, for example, selecting one of the gamepieces to move and selecting the number of spaces that the gamepieces is to move. A “race” may involve multiple “rolls” to create a final outcome.

According to another aspect of the disclosure, a method for playing a racing game of chance is also disclosed. The method may include the steps of providing a race course including a plurality of lanes each divided into an equal plurality of segments and a gamepiece associated with each of said lanes; placing a base wager by a player in a wagering area corresponding to one of the gamepieces; placing the gamepieces in an initial segment of the race course in a respective lane associated with the gamepiece; and conducting a plurality of rolls until one of the gamepieces is determined to be the winner. Each roll may include the substeps of: selecting using a first randomizer a gamepiece to move, selecting using a second randomizer a number of segments the gamepiece is to move within its lane, and moving the gamepiece selected by the first randomizer by a number of segments as indicated by the second randomizer. The method may proceed with the steps of determining after a roll is complete whether the selected gamepiece is a winner having moved beyond a finish line on the race course; determining the payout for each of the base wagers associated with the winner as the base wager times a payout multiplier; collecting the base wagers associated with the gamepieces not identified as the winner; and distributing the payout corresponding to each of the base wagers associated with the winner.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a top view of a table game with playing surface that includes a plain background according to an aspect of the present disclosure;

FIG. 2 is a top view of a table game with a playing surface that includes a decorative graphic background according to another aspect of the disclosure;

FIG. 3 is a perspective view of a table game with a pair of blower units, each filled with numbered balls according to an aspect of the present disclosure;

FIG. 4 is an enlarged perspective view of two betting positions with a gamepiece placed thereupon and a wagering chip placed on wagering area “5”;

FIG. 5 is an enlarged perspective view of the race course portion of a table game according to an aspect of the present disclosure;

FIG. 6 is a block diagram of components according to an aspect of the disclosure;

FIG. 7 is a flow chart for a method for playing a racing game of chance according to an aspect of the present disclosure;

FIG. 8 is a flow chart for a method for playing a racing game of chance according to an aspect of the present disclosure;

FIG. 9 is a flow chart for an additional method for playing a side bet of chance according to an aspect of the present disclosure; and

FIG. 10 is a flow chart for an additional method for playing a side bet of chance according to an aspect of the present disclosure.

### DESCRIPTION OF THE ENABLING EMBODIMENT

Referring to the Figures, wherein like numerals indicate corresponding parts throughout the several views, a table game is disclosed. More particularly, the present disclosure relates to a racing game 20 including a race course 22 that determines an outcome of a game of chance.

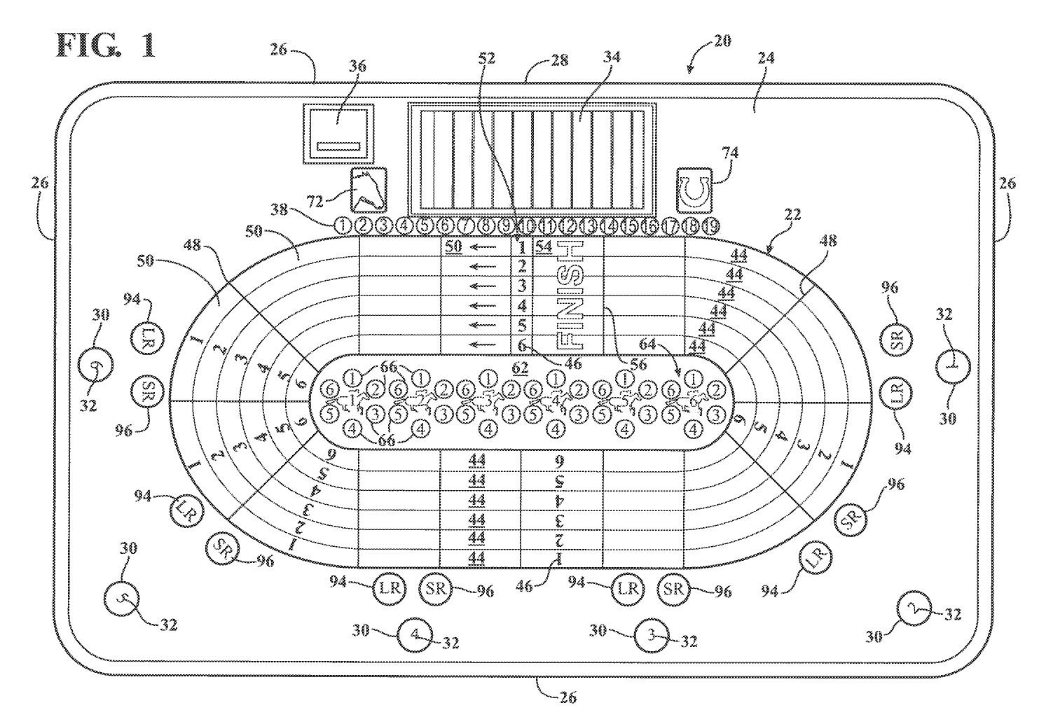

According to an aspect as best shown in FIG. 1, the racing game 20 may be provided as a table game including a playing surface 24 having a generally rectangular shape with four edges 26 with a dealer position 28 at the center of one of the edges 26. The playing surface 24 also includes and with a plurality of player positions 30 regularly spaced about the remaining ones of the edges 26. Each of the player positions 30 may have a second indicia 32 which may be a number 1-6 in the present format. Additional player positions may be used, with a corresponding addition of second indicia 32 to designate same. A variety of other indicia may also be employed to designate different areas of the playing surface 24 for different purposes related to playing the game. A chip tray 34 may be inset in the playing surface 24 adjacent the dealer position 28. A cash drop box 36 may also be inset in the playing surface 24 proximate to the dealer position 28. A roll number indicator 38 may be provided as a plurality of numbered circles for indicating the number of rolls completed to generate a winner. The roll number indicator may provide useful information to the dealer, players, and/or others such as casino management and security personnel to determine how many rolls have been completed at any given time and/or how many total rolls were completed in any given race. The number of rolls completed in a given race may impact one or more aspects of the racing game 20 according to the present disclosure.

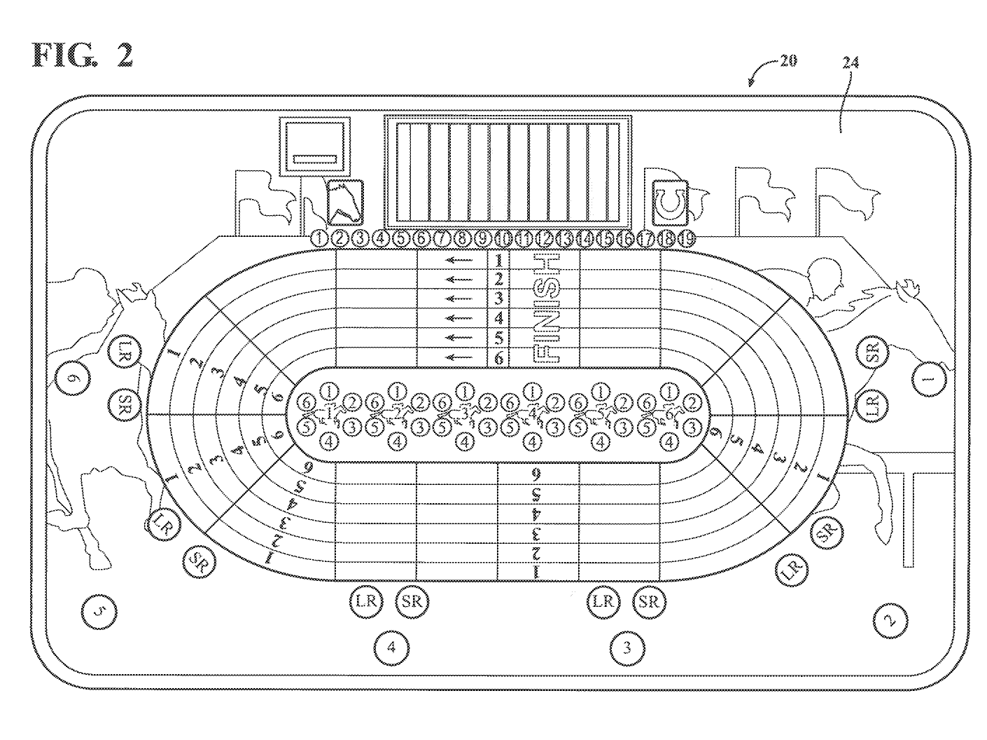

The playing surface 24 may include a background 37 that includes graphics or indicia to guide gameplay or as a decorative theme, such as the horse racing graphic shown in FIG. 2. The background 37 of the playing surface 24 may also be a solid color, such as shown in FIG. 1. The playing surface 24 may be adapted to other table shapes or configurations and may be fitted to new or pre-existing tables used in casino gaming, such as a blackjack table, craps tub, poker table, or any other shape or configuration.

According to an aspect, and as shown in FIGS. 1 and 2, the racing game 20 may include a race course 22 which may be centrally located on the playing surface 24 and which may have a generally oval shape with straight sections between semicircular ends. The race course 22 may include a plurality of lanes 44 arranged generally concentrically, and each lane 44 may be identified by a first indicia 46 such as a number 1-6, as shown in FIG. 1. A plurality of radial lines 48 may divide each of the lanes 44 into a plurality of segments 50, with each of the lanes 44 having the same number of segments 50. A first one 52 of the segments 50 may include a “START” indicia to demark the beginning and a finish segment 54 may include a “FINISH” indicia to demark the finish line 56 of the race course 22. The “START” indicia and/or the “FINISH” indicia may be symbolic or graphic, such as, for example, a starting gate and a checkered flag. A gamepiece 60, which may be stylized as a racehorse, such as, for example, by shape or coloration, may be disposed upon each of the lanes 44. The gamepieces 60 may be have other forms including, for example, cars, trucks, chariots, people, or dogs or other animals.

According to an aspect, the playing surface 24 may also include an infield area 62 in the central area of the race course 22 with a plurality of betting positions 64 equal in number to the lanes 44 and each having one of the first indicia 46 matching a corresponding one of the lanes 44. A plurality of wagering areas 66 may be provided around each of the betting positions 64 equal in number to the player positions 30 for placement of a base wager and an optional second wager by the player in the associated player position 30. Each of the wagering areas 66 may be marked, such as with the second indicia 32, to correlate with a corresponding one of the player positions 30.

According to an aspect, and as best shown in FIGS. 1-2, a first randomizer 72, which may be a card shuffler with a first deck of cards, may be disposed proximate the dealer position 28 such as at the dealer's right hand side. The first randomizer 72 may designate a gamepiece 60 to move. In the example of the first randomizer 72 being a card shuffler with a first deck of cards, the first deck of cards may be designated “horse cards” and the act of designating a gamepiece 60 to move may include singulating by the dealer a “horse card” from the first deck of cards with the singulated “horse card” indicating which of the gamepieces 60 to move such as by indicia on the card. According to an aspect, a second randomizer 74, which may be a card shuffler with a second deck of cards, may be disposed proximate the dealer position 28 such as at the dealer's left hand side. The second randomizer 74 may designate a number of segments 50 the selected gamepiece 60 is to move. The second randomizer 74 may be independent of the first randomizer 72, meaning that the outcome of the second randomizer 74 is not affected by the outcome of the first randomizer 72. In the example of the second randomizer 74 including a second deck of cards, the second deck of cards may be designated “advancement cards” and the act of determining the number of segments 50 to move may include singulating by the dealer an “advancement card” from the second deck of cards with the “advancement card” singulated indicating the number of segments 50 for the designated gamepiece 60 to move.

According to an aspect, each of the two decks of cards may have six cards. Each of the two decks may have more or fewer than six cards. The first deck of cards may have the same number or a different number of cards as the second deck of cards. The two decks of cards should each have a different colored backing or be otherwise visibly distinguishable from one another. According to another aspect, a single deck of cards may be used that includes both the “horse cards” and the “advancement cards.” Additional decks of cards may be pre-shuffled and ready to use when the cards of the first deck have all been dealt. In other words, the race may continue without the need for a delay associated with shuffling the cards.

It should be appreciated that any other means of randomly selecting one of the gamepieces 60 and one of the numbers of positions to move, and/or any combination thereof may be used in place of the two decks of cards. Examples include, but are not limited to the use of blower units each with a plurality of balls, dice, computerized random number generator (RNG) device or devices, or any other means of randomized selection. Such randomized selection devices may be restricted or dictated by applicable jurisdictional gaming laws. According to an aspect, the number of player positions may be varied without impacting the odds of the game for any individual player. However, varying the number of gamepieces 60 at play in a race will impact the odds of the game disallowing side wagers 94, 96.

According to an aspect, the subject racing game 20 may also be configured in a semi-automated format. In such a semi-automated format, card draws may be electronically selected and/or displayed via, for example, RFID, bar codes, or facial recognition technology. According to an aspect, in a semi-automated format the gamepiece 60 may be moved electronically. According to another aspect, the subject racing game 20 may be entirely electronic and may include a player terminal 90 which may include a video display 88 and a user input device 89, which may include one or more pushbuttons, a touchscreen, a keyboard, mouse, trackpad, or a combination of one or more such devices. As an entirely electronic version, the player terminal 90 may be configured similar to a video slot machine with software and an electronic gaming controller for regulating game play.

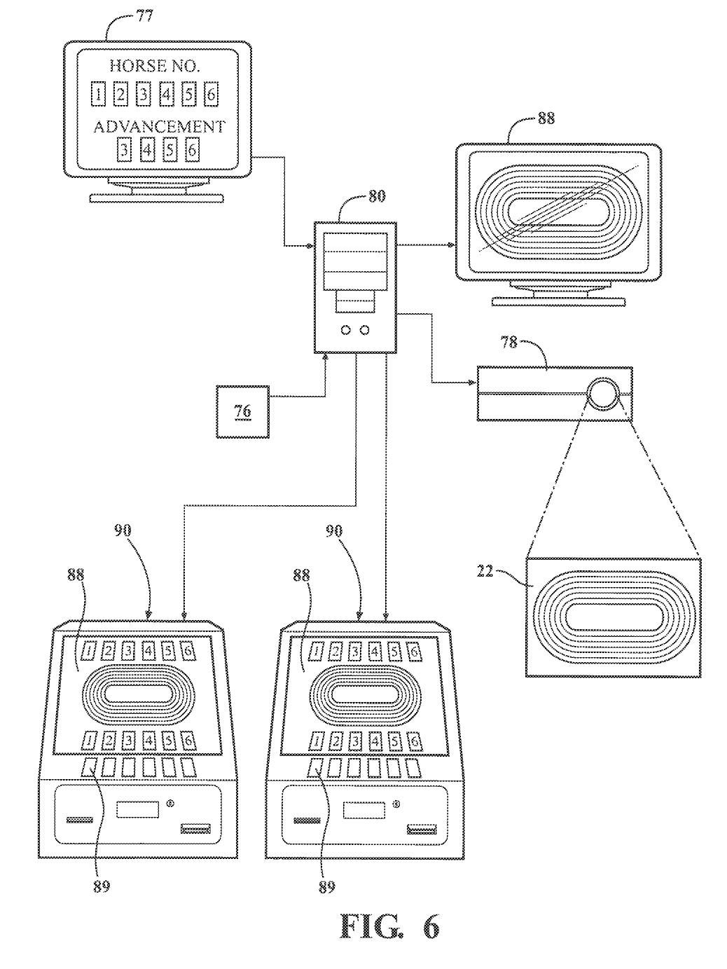

According to another aspect, and as best shown in FIG. 6, the subject racing game 20 may be played as a dealer-assisted electronic table game. Such a dealer-assisted electronic table game may include a digital reader 76 for determining the result of each of the randomizers 72, 74 and for communicating the results of the randomizers 72, 74 to a digital processor 80. Alternatively, a dealer console 77, which may include a touchscreen, may be provided for the dealer to input the result of each of the randomizers 72, 74 to the digital processor 80. The digital processor 80 may be a single computer processor device or it may be distributed amongst two or more devices. A projector 78 may selectively illuminate a destination one of the segments 50 where a selected one of the gamepieces 60 is to move. A dealer-assisted electronic table game may also include a video display 88.

A dealer-assisted electronic table game may include a plurality of player terminals 90 operatively connected to the digital processor 80, and including a user input device 89 for allowing the player to select one or more of said gamepieces to wager upon as well as the types of wagers to be placed. The player terminals 90 may also handle the collection of money for the wagers and/or the payouts to the players. The player terminals 90 may be located adjacent or proximate to the physical game table such as in a “stadium style” game, and/or they may be distributed in other locations away from the physical game table. The player terminals 90 may include a display screen for showing the status of the game, including, for example, the positions of the gamepieces 60 on the race course 22 and/or the results of the randomizers 72, 74.

Variations of the dealer-assisted electronic table game may be provided in which the digital processor 80 includes a random number generator (RNG), which is used for one or more of the randomizers 72, 74. According to another variation of the dealer-assisted electronic table game, the gamepieces 60 may exist only as projected light from the projector 78 and/or as images on a video display 88, and gameplay may be conducted without physical gamepieces 60 being moved about the race course 22. A history of each game may be stored by the digital processor 80 for review during or after the game.

According to an aspect, there may be only one winning gamepiece 60. According to another aspect, there may be more than one winning gamepiece 60, which may include a second place, third place, etc. In other words, there may be prizes or a portion of the winnings allocated to the player who picks gamepieces 60 that finish the race first, second, third, or a combination thereof. One, two or more players may each receive a payout based on wagers associated with the winning gamepiece 60 or gamepieces 60. According to an aspect, the race game may be completed after a single lap around the race course 22 from the first one 52 of the segments 50 to the finish line 56. Alternatively, the race game may require more than one lap around the race course 22 before a winner is determined. According to a further aspect, the beginning and the finish line 56 may be combined into a single start/finish line 56.

According to an aspect shown in FIGS. 1-2, the race course 22 will include six gamepieces 60, with a single gamepiece 60 in each lane 44. The gamepieces 60 will be initially positioned in the first one 52 of the segments 50. According to an aspect, the game may be played as a “house banked” game, otherwise known as a “Class III game” in which players wager against the gaming establishment (i.e. the “house”). According to an aspect, players may wager on any number of the gamepieces 60 to win the race as a chosen gamepiece 60. Players may place a wager, which may be in the form of one or more chips, in the wagering area 66 that corresponds with that player's player position 30 and adjacent the betting position that corresponds with the chosen gamepiece 60. According to an aspect, all wagers must be placed before the race is begun. The dealer may announce that the race is to begin and that all wagering must cease. The dealer may also signal that no more wagers are available by switching an indicating device (not shown), which may be a game puck that is flipped-over to show “On” and “Off” positions.

According to an aspect, the dealer may singulate a card from the first deck to select a gamepiece 60 to move. The dealer may also singulate a card from the second deck to select the number of positions or segments 50 for the selected gamepiece 60 to move. The dealer may then cause the selected gamepiece 60 to advance around the race course 22 in its designated lane 44 by the selected number of segments 50. The advancement of the gamepiece 60 may be done in a counterclockwise direction to mimic the action of a horse racing derby. If, after causing the gamepiece 60 to advance, no gamepiece 60 has reached the finish segment 54, the dealer may repeat the steps of singulating cards from each of the card decks and causing the gamepiece 60 to advance around the race course 22.

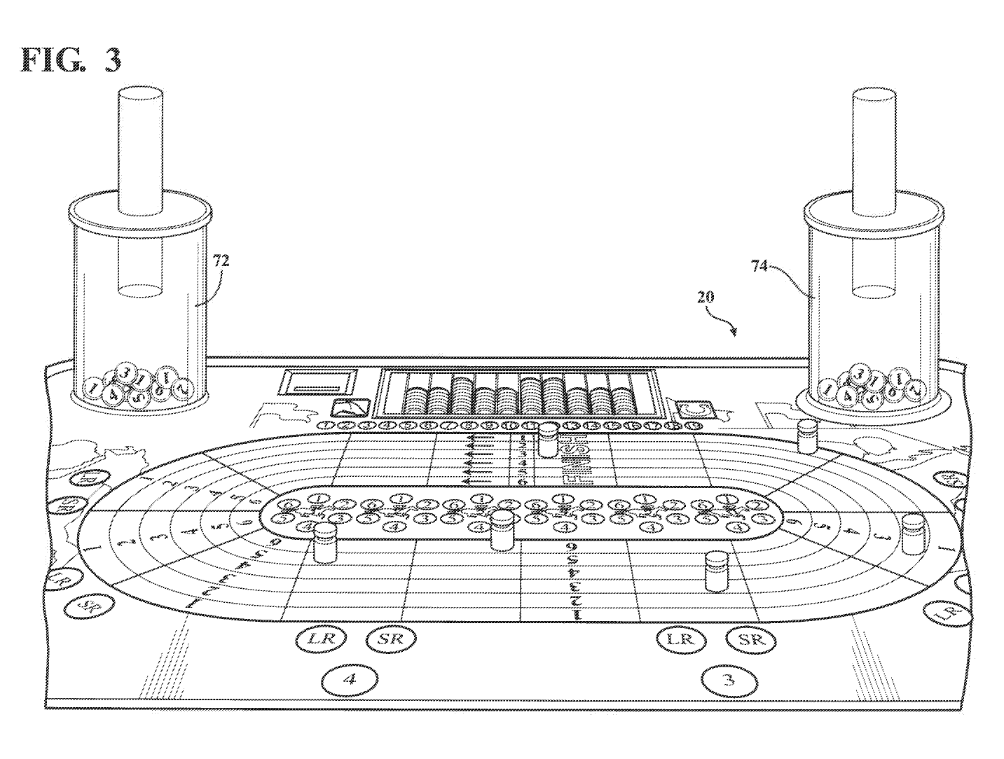

According to an alternative aspect, and as shown in FIG. 3, the dealer may singulate a ball from a first blower unit to select a gamepiece 60 to move. The dealer may also singulate a ball from a second blower unit to select the number of positions or segments 50 for the selected gamepiece 60 to move. The second deck or the second blower unit may be provided without cards or balls having low numbers such as 1 or 2 or 3. In this way, each time a card or ball is drawn, the respective gamepiece 60 will move at least a predetermined number of segments 50, which will greatly reduce the time needed to complete a race.

According to an aspect, the game may be played as a “player banked” game, otherwise known as a “Class II game” where players play against each other. In such a Class II game, if a given game piece 60 is the first to reach the finish segment 54, that gamepiece 60 is designated as the winner and each player who had wagered upon the winner may share a given portion of the wagers placed on gamepieces 60 that were not the first to reach the finish segment 54. According to an aspect, when a winner has been decided, the race is deemed to be ended and the dealer will then collect the wagers placed upon the non-winner gamepieces 60 and disburse the proceeds to the players who placed wagers on the winner gamepiece 60. The dealer will only divide the winnings in even dollars. Any funds let over will be placed in a carryover circle (not shown), which may be located in the infield 62, for distribution to the winner or winners in a subsequent race. Once the proceeds are disbursed, the dealer may return all gamepieces 60 to the first one 52 of the segments 50, or the starting line. The dealer may indicate that wagering is now open and may switch the indicating device to signal the same.

If a gamepiece 60 is the first to reach the finish segment 54 and there were no wagers associated with that gamepiece 60, the dealer may continue gameplay with the remaining gamepieces 60 until a gamepiece 60 that has been wagered upon is the first to reach the finish segment 54, and that gamepiece 60 is designated as the winner for purposes of disbursing the proceeds as a prize to the player or players who wagered upon the winner. This aspect may be particularly relevant in Class II games in which players wager against other players. This aspect may also be used in Class III games as well.

According to an alternative aspect, if a card is singulated that corresponds to a gamepiece 60 that does not have any wagers therewith, the dealer may continue singulating cards from the first deck to select another gamepiece 60 to move until a card is singulated that corresponds with a gamepiece 60 that has been wagered upon. In this way, only gamepieces 60 that have been wagered upon may advance around the race course 22.

According to an aspect, the racing game 20 may be played as a “minimal limit game.” In other words, a predetermined minimum bet is all that is required to be wagered. The playing surface 24 may include one or more wagering areas 66 corresponding to each of the gamepieces 60 for placement of a base wager. Each player who placed a base wager upon the winning one of the gamepieces 60, also called the winner, may receive a prize that is proportionate to the amount the base wager that player placed upon the winner. According to an aspect, the racing game 20 may provide a payout as a payout multiplier times each of the base wagers placed on the wagering area 66 corresponding to the winner. According to an aspect, the house may charge a collection fee from each player to cover its costs if playing in Class II format. According to an aspect, each player may bet on as many gamepieces 60 as they wish. According to an alternate aspect, each player may not bet on more than half of the gamepieces 60 in any given race.

According to an aspect, the winner may have a lead as the number of segments 50 that a next-closest one of the gamepieces 60 is to the finish line 56 when the winner reaches the finish segment 54. The racing game 20 may provide a payout multiplier that varies between two or more different values depending on the lead. In other words, a base wager upon a given gamepiece 60 may provide a first payout if that given gamepiece 60 wins by a lead less than a predetermined number of segments 50, and that same base wager upon the same given gamepiece 60 may provide a second payout different from the first payout if that given gamepiece 60 wins by a lead greater than or equal to the predetermined number of segments 50. The second payout is higher than the first payout. For example, the racing game 20 may provide a first payout based on a payout multiplier of 4:1 if the winner wins by a lead of 7 or fewer segments, and may provide a second payout based on a payout multiplier of 8:1 if the winner wins by a lead of 8 or more segments.

According to another aspect the racing game 20 may provide a second-place award for a second-place one of the gamepieces 60 as one of the gamepieces 60 other than the winner and which is closest to the finish line 56 at the time that the winner crosses the finish line 56. Likewise, the racing game 30 may provide a third-place award for a third-place one of the gamepieces 60 as one of the gamepieces 60 other than the winner and which is next-closest to the finish line 56 at the time that the winner crosses the finish line 56. Such second-place and third-place awards may be determined based on a predetermined payout multiplier which may be independent of the lead of the winner.

According to a further aspect, a player may place an optional second wager, which may be designated as a “higher wager”, as a Class II wager against one or more other players. The second wagers may be acted upon by the dealer at the end 42 of each race and before calculating the proceeds to be disbursed to the players based upon their base wagers. A base wager that is equal to the designated predetermined minimum bet amount may be required to be placed upon each gamepiece 60 upon which a player also places an optional second wager. In other words, a player must place a base wager upon a given gamepiece 60 to be eligible to place a second wager upon that same given gamepiece 60. Second wagers may also be placed having different values. For example, the base wager may be $5, and two players A and B may place second wagers of $25 on top of their base wagers on two different respective gamepieces 60, which would only be effective between A and B and only if one of the respective gamepieces 60 is the winner. At the same time, players C, D, and E may place second wagers of $100 on top of their base wagers on different respective gamepieces 60, and with their $100 second wagers only being effective between C, D, and E and only if one of those respective gamepieces 60 is the winner. In other words, each of the second wagers at each given value may be pooled separately and paid to one of the players who placed a second wager at that same given value (e.g. $25 against other $25 betters, $100 against other $100 betters etc.). A second wager may require two or more players to wager the same value. If a player posts a second wager at any given dollar amount and no other players place second wagers for the same dollar amount, that second wager may be returned to the player. If none of the players at a given value is the winner, then each of the second wagers at that given value may be returned to the player who placed it. In keeping with the example above, if players C, D, and E each place second wagers of $100 on gamepieces 60 1, 2, and 3, respectively, and the winner is gamepiece 4, then the $100 second wagers may each be returned to players C, D, and E.

According to an aspect, the dealer may only disburse winnings in predetermined increments, such as whole dollars. In disbursing the proceeds, there may be a remainder amount that cannot be disbursed evenly between winners using the predetermined increments. In this case, the remainder amount may carry-over and be added to the winning pool for the next race.

According to an aspect, the rules that govern the method of gameplay may be different depending on the number of players. In other words, one set of rules may be used on a short field with, for example, three or fewer players; another set of rules may be used with four or more players.

According to an aspect, the racing game 20 may provide for a long-race wager, which may be separate and independent from any other wager, and which may provide a long-race payout having a multiplier value that varies depending on the number of rolls or play turns before a gamepiece 60 is declared the winner, and which may also be called the “Race Length”. A player may be required to place a base wager upon one or more gamepieces 60 to be eligible to place a long-race wager. The long-race wager may, for example, provide a long-race payout as a multiple of the long-race wager according to the paytable shown in Table 1, below. A version of Table 1 may be displayed on the playing surface 24.

TABLE 1

| Race Length | Payout |
|---|---|
| 11 or Fewer Rolls | Loss |
| 12 Rolls | 2 to 1 |
| 13 Rolls | 2 to 1 |
| 14 Rolls | 3 to 1 |
| 15 Rolls | 5 to 1 |
| 16 Rolls | 10 to 1 |
| 17 Rolls | 15 to 1 |
| 18 Rolls | 25 to 1 |
| 19 Rolls | 100 to 1 |

According to an aspect, the racing game 20 may provide for a short-race wager, which may be separate and independent from any other wager, and which may provide a short-race payout having a multiplier value that varies depending on the number of rolls or play turns before a gamepiece 60 is declared the winner, and which may also be called the “Race Length”. A player may be required to place a base wager upon one or more gamepieces 60 to be eligible to place short-race wager. The short-race wager may, for example, provide a short-race payout as a multiple of the short-race wager according to the paytable shown in Table 2, below. A version of Table 2 may be displayed on the playing surface 24.

TABLE 2

| Race Length | Payout |
|---|---|
| 3 Rolls | 10 to 1 |
| 4 Rolls | 5 to 1 |
| 5 Rolls | 3 to 1 |
| 6 Rolls | 2 to 1 |
| 7 Rolls | 1 to 1 |
| 8 or More Rolls | Loss |

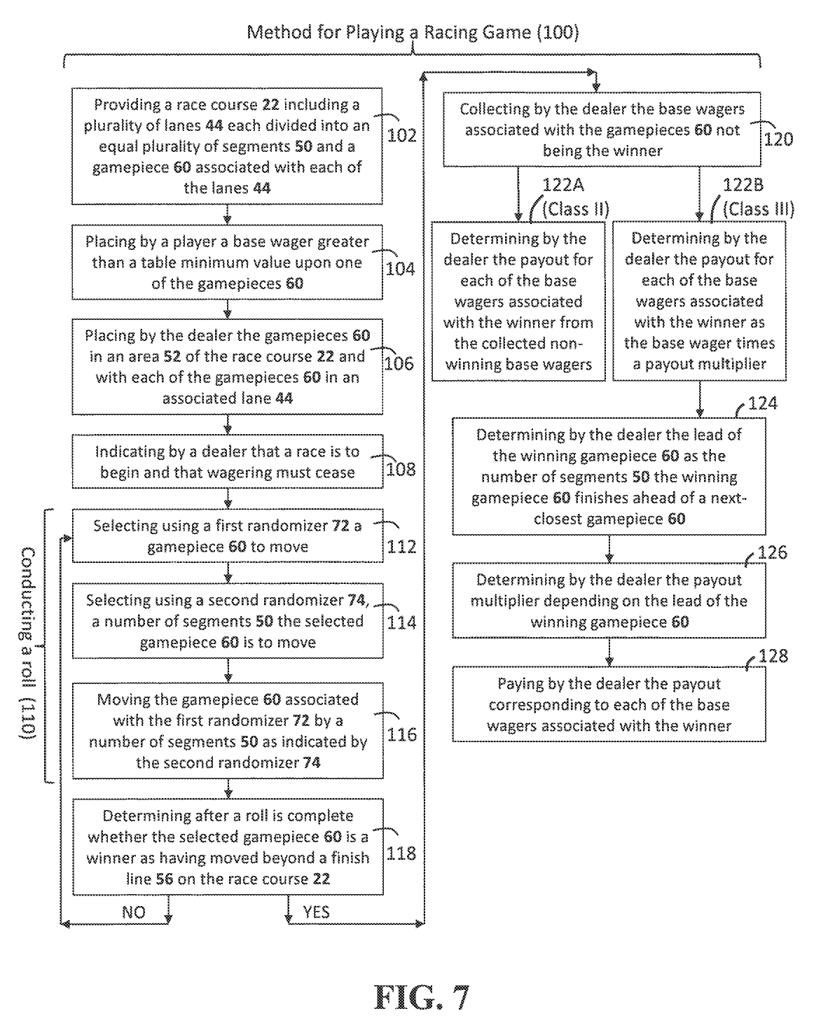

A method 100 for playing a racing game 20 of chance is also disclosed and described in the flow chart of FIG. 7. The method 100 comprises the steps of 102 providing a race course 22 including a plurality of lanes 44 each divided into an equal plurality of segments 50 and a gamepiece 60 associated with each of the lanes 44; 104 placing by a player a base wager greater than a table minimum value upon one of the gamepieces 60. In the case of the racing game 20 being provided as a table game, the step of 104 wagering may be performed by placing a wagering chip upon a wagering area 66 associated with the one of the gamepieces 60. Other means of wagering may also be performed such that an amount to be wagered is associated with one or more of the gamepieces 60. The method 100 may proceed with the steps of: 106 placing by the dealer the gamepieces 60 in an initial segment 50 of the race course 22 and with each of the gamepieces 60 in an associated lane 44; 108 indicating by a dealer that a race is to begin and that wagering must cease; and 110 conducting by the dealer a roll to advance one of the gamepieces 60 along said race course 22.

The step of 110 conducting by the dealer a roll may include the substeps of 112 selecting using a first randomizer 72 a gamepiece 60 to move. The first randomizer 72 may be a card drawn from a first shuffler; and 114 selecting using a second randomizer 74, a number of segments 50 the selected gamepiece 60 is to move. The second randomizer 74 may be a card drawn card from a second shuffler. The step of 110 conducting a roll may continue with the substeps of 116 moving the gamepiece 60 associated with the first randomizer 72 by a number of segments 50 as indicated by the second randomizer 74.

The method 100 may proceed with the step of 118 determining after a roll is complete whether the selected gamepiece 60 is a winner as having moved beyond a finish line 56 on the race course 22. The method 100 may include repeating by the dealer the step of 110 conducting a roll until one of the gamepieces 60 is determined to be the winner. If a gamepiece 60 is determined to be the winner, the method 100 may proceed with the steps of 120 collecting by the dealer the base wagers associated with the gamepieces 60 not being the winner.

The method 100 may include different steps for determining the payout for the base wagers associated with the winner depending on the type of game being played. For a “player vs. player” or a Class II type game, the method 100 may include 122A Determining by the dealer the payout for the base wagers associated with the winner from the collected non-winning base wagers. According to an aspect, the payout may be divided only in predetermined increments, such as in whole dollars. Any funds let over after the payouts are distributed may be placed in a carryover circle (not shown), which may be located in the infield 62, to be distributed to the winner or winners in a subsequent race.

For a “minimal limit” or a Class III type game, the 100 may include 122B determining by the dealer the payout for each of the base wagers associated with the winner as the base wager times a payout multiplier. The method 100 may also include the optional steps of 124 determining by the dealer the lead of the winning gamepiece 60 as the number of segments 50 the winning gamepiece 60 finishes ahead of a next-closest gamepiece 60; and 126 Determining by the dealer the payout multiplier depending on the lead of the winning gamepiece 60 from a first multiplier, which may be, for example 4:1 if the lead of the winning gamepiece 60 is less than a predetermined number of segments 50, which may be, for example 7 segments 50 or a second multiplier, which may be, for example 8:1 if the lead of the winning gamepiece 60 is greater than or equal to the predetermined number of segments 50 between two or more different values depending on the lead of the winning gamepiece 60. The method 100 may conclude with the step of 128 paying by the dealer the payout corresponding to each of the base wagers associated with the winner.

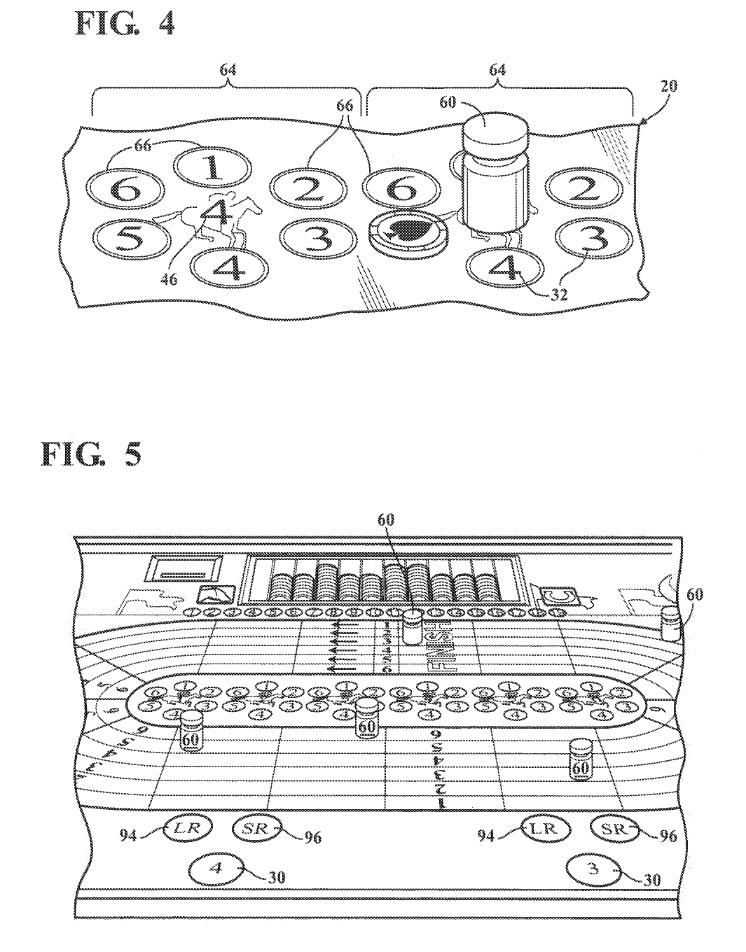

According to an aspect, the dealer may move the winning gamepiece 60 to a specific location. As shown in FIG. 4, the specific location for the winning gamepiece 60 may be the corresponding betting position 64 within the infield area 62.

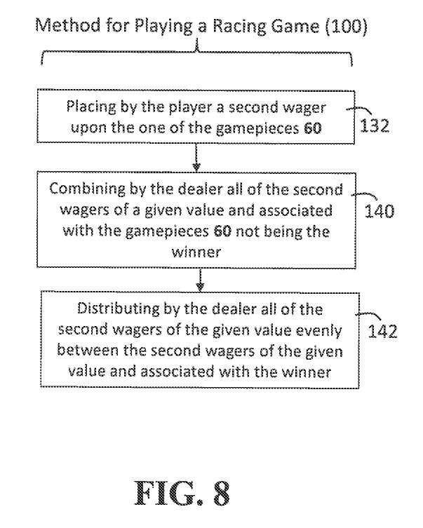

As shown in the flowchart of FIG. 8, the method 100 may also include the optional steps of 132 placing by the player a second wager upon one of the gamepieces 60, which may be performed by, for example, placing a second wagering chip upon the first wagering chip used for the base wager; and 140 combining by the dealer all of the second wagers of a given value and associated with the gamepieces 60 not being the winner; and 142 distributing by the dealer all of the second wagers of the given value evenly between the second wagers of the given value and associated with the winner. The second wager (and each of steps 132-142) may be Class II gaming involving betting against a player bank.

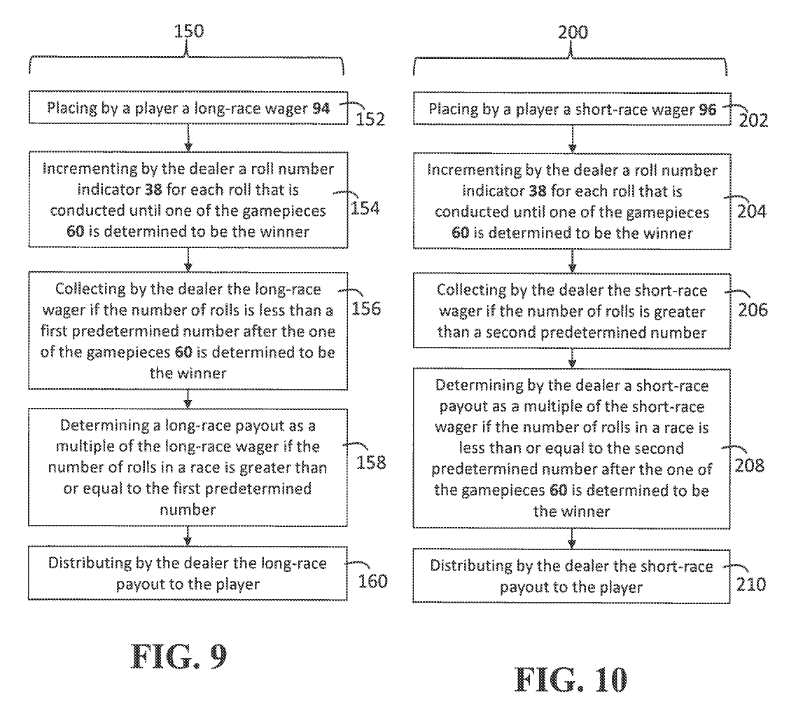

As shown in the flowchart of FIG. 9, an optional method 150 for a long-race wager may be combined with the method 100 for playing a racing game 20 of chance and may further comprise the steps of: 152 placing by a player a long-race wager; 154 incrementing by the dealer a roll number indicator 38 for each roll that is conducted until one of the gamepieces 60 is determined to be the winner; 156 collecting by the dealer the long-race wager if the number of rolls is less than a first predetermined number after the one of the gamepieces 60 is determined to be the winner; 158 determining by the dealer a long-race payout as a multiple of the long-race wager if the number of rolls in a race is greater than or equal to the first predetermined number. The long-race payout may be determined according to predetermined correlation, such as the paytable shown in Table 1, with a minimum multiple associated with the first predetermined number of rolls and higher multiples associated with a numbers of rolls greater than the first predetermined number; and 160 distributing by the dealer the long-race payout to the player.

As shown in the flowchart of FIG. 10, an optional method 200 for a short-race wager may be combined with the method 100 for playing a racing game 20 of chance and may further comprise the steps of: 202 placing by a player a short-race wager; and 204 incrementing by the dealer a roll number indicator 38 for each roll that is conducted until one of the gamepieces 60 is determined to be the winner; 206 collecting by the dealer the short-race wager if the number of rolls completed is greater than a second predetermined number. The step of 206 collecting by the dealer the short-race wager may be done immediately after the number of rolls conducted in that race exceeds the second predetermined number. In other words, the dealer does not need to wait for a winner to be determined. Performing the step of 206 collecting the short-race wager immediately after the number of rolls exceeds the second predetermined number may minimize the chances for players to cheat by pulling-back a losing short-race wager. The method 200 for a short-race wager may continue with the steps of 208 determining by the dealer a short-race payout as a multiple of the short-race wager if the number of rolls in a race is less than or equal to the second predetermined number after the one of the gamepieces 60 is determined to be the winner. The short-race payout may be determined according to predetermined correlation such as the paytable shown in Table 2, with a minimum multiple associated with the second predetermined number of rolls and higher multiples associated with a numbers of rolls less than the second predetermined number, and 210 distributing by the dealer the short-race payout to the player.

Variations of the racing game 20 may be played with or without a dealer and with or without electronic equipment. The racing game 20 may be played without a dealer such as, for example, as a video slot machine. The racing game 20 may also be played as a dealer-assisted electronic table game, in which at least some of the methods steps are performed by a digital processor 80 and/or other equipment which may include a player terminal 90, a display screen 88 and/or a projector 78.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In addition, the reference numerals in the claims are merely for convenience and are not to be read in any way as limiting.

What is claimed is:

1. A racing game comprising:
a race course including a plurality of lanes arranged generally concentrically and divided into a plurality of segments with each of said lanes having the same number of segments, and a finish line associated with a last one of said segments;
a gamepiece disposed upon and movable about each of said lanes in a race from an initial position upon a first one of said segments until one of said gamepieces first crosses said finish line and is thereby designated as a winning one of said gamepieces;
a first randomizer for determining a selected one of the gamepieces to be moved;
a second randomizer independent of said first randomizer for determining a number of segments said selected one of the gamepieces is to move;
a wagering area corresponding to each of said gamepieces for placement of a base wager; and
wherein said racing game provides a payout as a payout multiplier times each of said base wagers placed on said wagering area corresponding to said winning one of said gamepieces.

2. The racing game according to claim 1 wherein said winning one of said gamepieces has a lead as the number of segments that a next-closest one of the gamepieces is to said finish line when said winning one of said gamepieces first crosses said finish line; and
wherein said payout multiplier varies between two or more different values depending on said lead.

3. The racing game according to claim 1 further including a second wager being placed within said wagering area in addition to said base wager; and
wherein a given one of said second wagers placed on said wagering area corresponding to said winning one of said gamepieces is paid a portion of the total of all of said second wagers placed on said wagering areas not corresponding to said winning one of said gamepieces and having a value equal to said given one of said second wagers.

4. The racing game according to claim 1 wherein said gamepieces are stylized as racehorses.

5. The racing game according to claim 1 wherein at least one of said randomizers is a shuffler including a deck of cards.

6. The racing game according to claim 1 wherein at least one of said randomizers is a blower unit including a plurality of balls.

7. The racing game according to claim 1 wherein at least one of said randomizers includes one or more dice.

8. The racing game according to claim 1 configured as a table game with
said race course disposed upon a playing surface with a dealer position and with a plurality of player positions.

9. The racing game according to claim 1 wherein said racing game is configured as a dealer-assisted electronic table game comprising:
one of a manual input device or a digital reader for communicating the results of said randomizers to a digital processor; and
a player terminal operatively connected to said digital processor for allowing a player to select one or more of said gamepieces to wager upon.

10. The racing game according to claim 9 further including a projector for selectively illuminating a destination one of said segments where a selected one of said gamepieces is to move.

11. The racing game according to claim 1 wherein said racing game is configured as an electronic game comprising:
a display screen for presenting a video image of said race course and said gamepieces;
a user input device for allowing a player to interact with said racing game and to select one or more of said gamepieces to wager upon;
a digital processor operatively disposed between said user input device and said display screen for generating a video image of said race course; and
wherein said randomizers include random number generators controlled by said digital processor.

12. The racing game according to claim 1 further comprising:
a roll number indicator for indicating a number of rolls of moving a selected gamepiece within one of said races; and
a long-race wagering area for allowing each player to place a long-race wager providing a long-race payout as a multiple of the long-race wager if the number of rolls in the race is greater than or equal to a first predetermined number and wherein said long-race payout varies according to the number of rolls completed in the race, and wherein the long-race payout provides a payout ratio that increases with a higher number of rolls.

13. The racing game according to claim 1 further comprising:
a roll number indicator for indicating the number rolls of moving a selected gamepiece within a race; and
a short-race wagering area for allowing each player to place a short-race wager providing a short-race payout as a multiple of the short-race wager as a multiple of the short-race wager if the number of rolls in the race is less than or equal to a second predetermined number and wherein said short-race payout varies according to the number of rolls completed in the race, and wherein the short-race payout provides a payout ratio that increases with a lower number of rolls.

14. A table game comprising:
a playing surface having a generally rectangular shape with four edges, said playing surface having a dealer position on one of said edges and with a plurality of player positions located about the remaining ones of said edges;
a race course on said playing surface and having a generally oval shape and including a plurality of lanes arranged generally concentrically with a plurality of radial lines dividing each of said lanes into an equal plurality of segments, with each of said lanes being marked with a first indicia;
a gamepiece disposed upon each of said lanes;
a first randomizer for determining a selected one of the gamepieces to be moved;
a second randomizer for determining a number of segments said selected one of the gamepieces is to move;
an infield area in the central area of said race course with a plurality of betting positions equal in number to said lanes and each having one of said first indicia matching a corresponding one of said lanes, and
an equal plurality of wagering areas adjacent each of said betting positions as the number of player positions with each of said wagering areas having a second indicia matching a corresponding one of said player positions.

15. A method for playing a game of chance comprising:
providing a race course including a plurality of lanes each divided into an equal plurality of segments and a gamepiece associated with each of said lanes;
placing by a player a base wager upon one of the gamepieces;
placing the gamepieces in an initial segment of the race course and with each of the gamepieces in an associated lane;
conducting a plurality of rolls each including the substeps of: selecting using a first randomizer a gamepiece to move, selecting using a second randomizer a number of segments the gamepiece is to move, and moving the gamepiece selected by the first randomizer by a number of segments as indicated by the second randomizer;
determining after a roll is complete whether the selected gamepiece is a winner having moved beyond a finish line on the race course;
determining a payout for each of the base wagers associated with the winner as the base wager times a payout multiplier;
collecting the base wagers associated with the gamepieces not being the winner; and
distributing the payout corresponding to each of the base wagers associated with the winner.

16. The method for playing a game of chance according to claim 15 and further comprising:
wagering by the player a second wager upon the one of the gamepieces;
combining all of the second wagers of a given value and associated with the gamepieces not being the winner and distributing all of the second wagers of the given value evenly between the second wagers of the given value and associated with the winner.

17. The method for playing a game of chance according to claim 15 and further comprising:
determining the lead of the winner as the number of segments that a next-closest one of the gamepieces is to the finish line when winner first crosses said finish line; and
determining the payout multiplier as one of two or more different values depending on the lead of the winner.

18. The method for playing a game of chance according to claim 15 and further comprising:
incrementing a roll number indicator for each roll that is conducted until one of the gamepieces is determined to be the winner;
placing by a player a long-race wager;
collecting the long-race wager if the number of rolls is less than a first predetermined number after the one of the gamepieces is determined to be the winner;
determining a long-race payout as a multiple of the long-race wager if the number of rolls in a race is greater than or equal to the first predetermined number, wherein the long-race payout is determined according to predetermined correlation with a minimum multiple associated with the first predetermined number and higher multiples associated with a numbers of rolls greater than the first predetermined number; and
distributing the long-race payout to the player.

19. The method for playing a game of chance according to claim 15 and further comprising:
incrementing a roll number indicator for each roll that is conducted until one of the gamepieces is determined to be the winner;
placing by a player a short-race wager;
collecting the short-race wager if the number of rolls is greater than a second predetermined number;
determining a short-race payout as a multiple of the short-race wager if the number of rolls in a race is less than or equal to the second predetermined number after the one of the gamepieces is determined to be the winner, wherein the short-race payout is determined according to predetermined correlation with a minimum multiple associated with the second predetermined number and higher multiples associated with a numbers of rolls less than the second predetermined number; and
distributing the short-race payout to the player.
